(19) United States
(12) Patent Application Publication
(10) Pub. No.: US 2026/0257387 A1
(43) Pub. Date: Sep. 3, 2026

(54) RAZOR CARTRIDGE WITH TRIMMER ASSEMBLY

(71) Applicant: Harry's, Inc., New York, NY (US)

(72) Inventors: Stefan SENS, Ridgewood, NY (US); Kevin SKEUSE, New York, NY (US); Justin RILEY, Needham, MA (US)

(21) Appl. No.: 19/068,488

(22) Filed: Mar. 3, 2025

(51) Int. Cl. B26B 21/22; B26B 21/40

(52) U.S. Cl. CPC B26B 21/222; B26B 21/4018; B26B 21/4025; B26B 21/4075

(57) ABSTRACT

A razor cartridge having a housing with one or more primary blades mounted in a primary blade plane on a front surface and a channel within a rear surface, the channel extending inwardly from the rear surface toward the front surface, and a trimmer blade assembly comprising a trimmer blade attached to a trimmer blade support, the trimmer blade support comprising a trimmer blade guard, where the trimmer blade assembly is mounted on a first interior wall of the channel and a portion of the housing adjacent a second interior channel wall opposite the first interior channel wall comprises a trimmer blade cap. Also, a method of manufacturing the razor cartridge with the trimmer assembly attached to an interior channel wall.

### FIELD OF THE INVENTION

The present invention relates to a razor cartridge and, more particularly, to a razor cartridge having a trimmer blade for close or precision work, located on a part of the razor cartridge independent of the primary shaving blades.

### BACKGROUND OF THE INVENTION

Shaving razors generally use razor cartridges that comprise one or more primary shaving blades manufactured integrally with a blade guard and a blade cap to define a primary shaving plane that travels across the user's skin for hair removal. Such razor cartridges are generally considered disposable, being removable and replaceable on a reusable handle. However, for the purposes of the present application, the razor cartridge can be considered permanently affixed to the handle, such as found on disposable razors.

As razor cartridges evolved, the concept of adding a dedicated trimmer blade to the razor cartridge separate from the primary blades became popular, where the trimmer blade was affixed to the razor cartridge independent from the primary shaving blades. One of the first examples of an independent trimmer blade incorporated onto a razor cartridge having primary blades is found in Rozenkranc, U.S. Pat. No. 6,276,061, which describes a trimmer blade extending from a portion of the razor cartridge in a plane separate from the plane of the primary blades.

Following Rozenkranc were a number of examples where trimmer blades are incorporated onto a razor cartridge having one or more independent primary blades. For example, U.S. Pat. Nos. 7,761,999 and 8,261,451, both to Macove, describe a razor cartridge where a trimmer blade assembly, including the trimmer blade, a trimmer blade guard and a trimmer blade cap, is affixed to a razor cartridge, thereby forming a trimmer blade plane that is directionally opposed to the plane of the primary blades. Another example is found in U.S. Pat. No. 7,617,607 to Pennell, which describes the trimmer blade being formed on a trimmer blade assembly comprising a sheet metal blade carrier with the trimmer guard and trimmer cap, the trimmer assembly being affixed to the top surface of a razor cartridge having primary blades on a front surface.

Moreover, trimmer blades and trimmer blade assemblies are described as being attached to razor cartridges in a variety of different ways. In one example, U.S. Pat. No. 7,761,999 to Macove describes attaching the trimmer assembly to the razor cartridge by fusing, cementing or bonding. U.S. Pat. No. 7,669,335 to Walker describes attaching a trimmer assembly to a razor cartridge with the clips used to retain the primary blades on the cartridge. In contrast, U.S. Pat. Nos. 11,518,054 and 12,030,200, both to Kim, describe attaching a trimmer blade assembly with a trimmer cap to a rear surface of a razor cartridge using coupling parts that snap onto the sides of the cartridge frame.

In still other examples, the trimmer blade is locked into place on the razor cartridge by positioning the blade between separate elements of the razor cartridge, thereby “sandwiching” the trimmer blade or trimmer assembly into place on the razor cartridge. Examples of this method of attaching a trimmer blade to a razor cartridge can be found in U.S. Pat. Nos. 10,155,321 and 10,543,610, both to Bozikis.

However, the foregoing methods of forming and attaching a trimmer blade or trimmer assembly are not both effective and efficient in providing a trimmer blade on a razor cartridge. In this regard, it is not only important that the trimmer blade have a proper and consistent trimming plane between a trimmer guard and trimmer cap, but that the trimmer blade be properly placed on the razor cartridge for ease of use.

In keeping, there is a need for a razor cartridge with an effective trimmer blade that provides an efficient method of incorporating the trimmer blade onto the razor cartridge for effective trimming by the user.

### SUMMARY OF THE INVENTION

The present invention is directed to a razor cartridge comprising a housing with one or more primary blades mounted in a primary blade plane, including a primary blade guard and a primary blade cap on a front surface of the housing, a channel within a rear surface of the housing, said channel extending inwardly toward the front surface, and a trimmer blade assembly comprising a trimmer blade and a trimmer blade support, said trimmer blade support comprising a trimmer blade guard, wherein the trimmer blade assembly is mounted on a first interior wall of the channel, and a portion of the housing adjacent a second channel wall opposite the first channel wall comprises a trimmer blade cap.

The trimmer blade support can be made of any suitable material, with plastic being preferred. Moreover, the trimmer blade can be attached to the trimmer blade support in any suitable manner, including by welding, sonic welding, cold forming, catches, snaps, pins, adhesives, etc. In one preferred embodiment, a plastic blade support is formed with one or more projections that are passed through corresponding apertures in the trimmer blade and then melted and pressed, sonic welded, cold formed, etc., to hold the trimmer blade to the trimmer blade support.

Of course, the trimmer blade support can be formed of other materials, such as a metal, with the trimmer blade being attached by suitable related means, including welding, rivets, guides, etc.

An important aspect of mounting the trimmer blade on the trimmer blade support is that the trimmer blade should mounted to the trimmer blade support at a fixed, predetermined distance that allows for a portion of the trimmer blade support to act as the trimmer guard.

In an embodiment, one or more cooperating rails and rail guides are formed on cooperating surfaces of the first channel interior wall and a portion of the trimmer blade support opposite the trimmer blade, so that the trimmer blade assembly can slide into the channel on the cooperating rails and rail guides. In a preferred embodiment, the one or more rails and cooperating rail guides are formed in dovetail configurations to not only guide the trimming blade support into proper alignment in the channel, but also to draw down and retain the trimming blade support against the first interior channel wall.

Also preferred is the use of one or more additional alignment projections that assist in properly positioning and retaining the trimmer blade assembly in the channel. For example, alignment projections can extend from, or comprise a portion of a shelf or slot within, opposed lateral channel walls to act on cooperating end portions of the trimmer blade assembly, and preferably the trimmer blade support, to hold the ends of the trimmer blade assembly in place against the first interior channel wall.

The trimmer blade assembly is permanently retained in the channel by any suitable means, including welding, cold forming, adhesives, cooperating snap-fit elements, pins, etc. In a preferred embodiment, one or more cooperating snap-fit protrusions and catches on corresponding portions of the trimmer blade support and the first channel wall engage each other to secure the trimmer blade assembly within the channel. For example, two spaced apart snap-fit projections on the first channel interior wall can snap together with two corresponding catches on the trimmer blade support to secure the trimmer blade assembly within the channel.

In the preferred trimmer blade assembly, the trimmer blade support extends beyond the cutting edge of the trimmer blade, with a space between the cutting edge of the trimmer blade and the trimmer blade support, so that the end of the trimmer blade support can act as the trimmer guard. Moreover, the trimmer blade can extend substantially parallel to the first interior channel wall on which the trimmer blade assembly is mounted, with a space between the trimmer blade and a second interior channel wall opposite the first interior channel wall. A portion of the cartridge housing adjacent the second interior channel wall, not extending as far as the cutting edge of the trimmer blade, can then form the trimmer cap to complete the trimmer plane with the trimmer guard and trimmer blade cutting edge.

In one embodiment, the portion of the cartridge housing adjacent the second interior channel wall forming the trimmer cap corresponds to a truncated top surface of the cartridge housing, so that the cutting edge of the trimmer blade extends beyond the top surface of the cartridge housing. The end of the trimmer blade support forming the trimmer guard, the trimmer blade cutting edge and the cartridge housing adjacent the channel wall opposite the first interior channel wall, preferably at the top surface of the cartridge housing, thereby create the trimmer plane.

The present invention also comprises a method of manufacturing a razor cartridge with a trimmer blade. The method preferably comprises providing a cartridge housing with primary shaving blades on a front surface and a channel on a rear a surface, said channel extending inwardly toward the front surface and comprising one or more rails or rail guides on a first interior channel wall; providing a trimmer blade assembly comprising a trimmer blade attached to a trimmer blade support, said trimmer blade support comprising one or more rails or rail guides for cooperating with the one or more rails or rail guides on the interior channel wall; sliding the trimmer blade support into the channel on the cooperating one or more rails and rail guides; and fixing the trimmer blade assembly against the first interior channel wall.

### BRIEF DESCRIPTION OF THE DRAWINGS

The attached drawings, in which like reference characters represent like parts, are intended to better illustrate a preferred embodiment of the present invention without limiting the invention in any manner whatsoever.

FIG. 1 is an exploded rear perspective view of an embodiment of the present invention.

FIG. 2 is a rear perspective view of the cartridge housing of FIG. 1.

FIG. 3 is a close-up section of the channel on the rear surface of the cartridge housing shown in FIG. 2.

FIG. 4 is a front perspective view of the trimmer blade assembly of FIG. 1.

FIG. 5 is a close-up section of the trimmer blade assembly shown in FIG. 4.

FIG. 6 is a cross sectional rear elevation showing the trimmer blade assembly affixed to the interior channel wall of the cartridge housing.

FIG. 7 is close-up section of the cross sectional rear elevation shown in FIG. 6.

FIG. 8 is a cross sectional side elevation showing the trimmer blade assembly affixed to the interior channel wall of the cartridge housing.

### DETAILED DESCRIPTION OF THE PREFERRED EMBODIMENT

The following description of the preferred embodiment the present invention is intended to describe the invention without limiting its scope in any manner whatsoever.

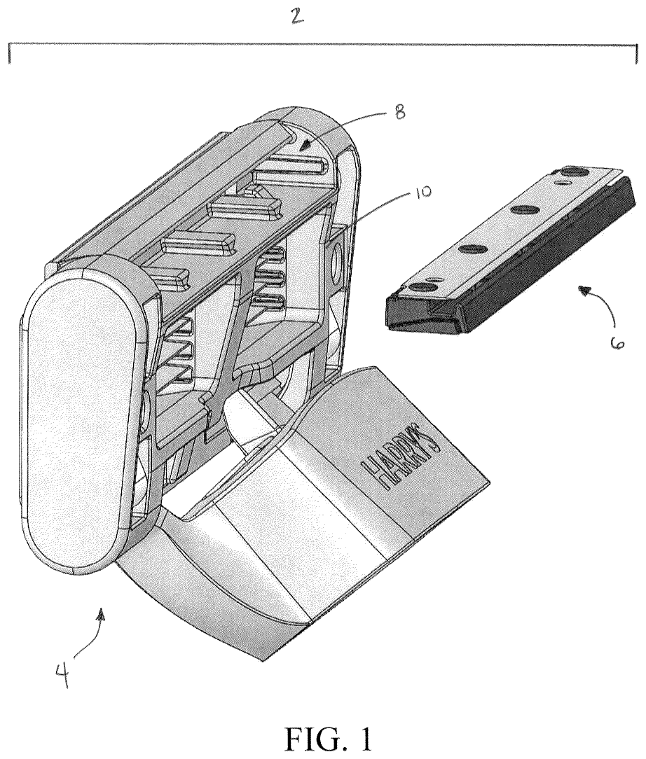

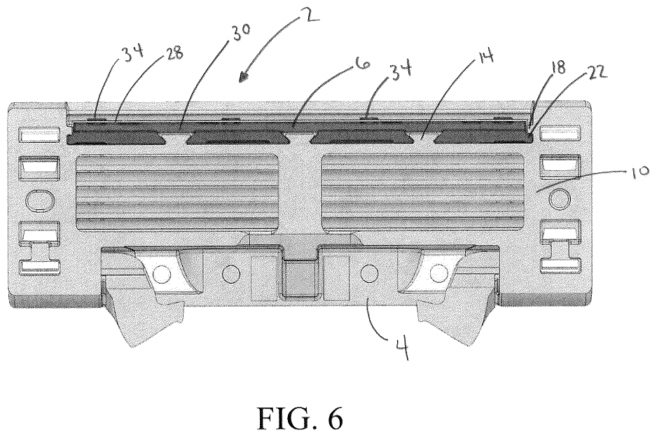

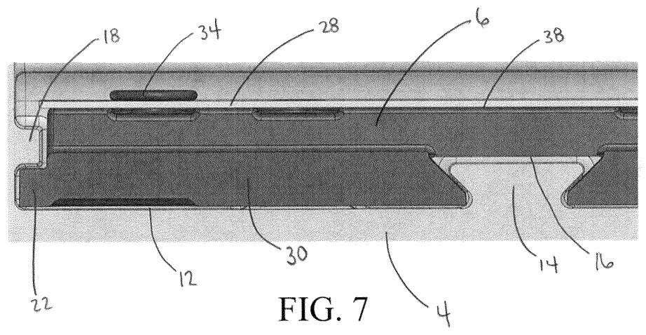

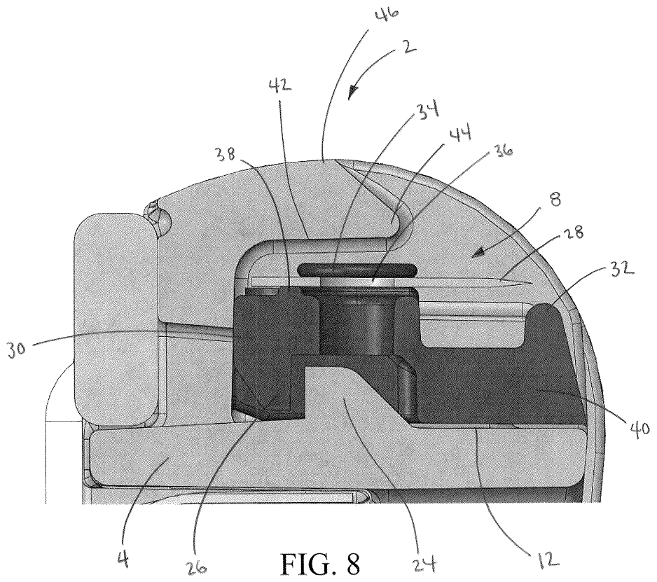

As shown in FIGS. 1 and 6-8 the present invention is directed to a razor cartridge 2 comprising a cartridge housing 4 for mounting one or more primary blades in a primary blade plane on a front surface (not shown) and a trimmer blade assembly 6 mounted in a channel 8 within a rear surface 10 of the cartridge housing 2.

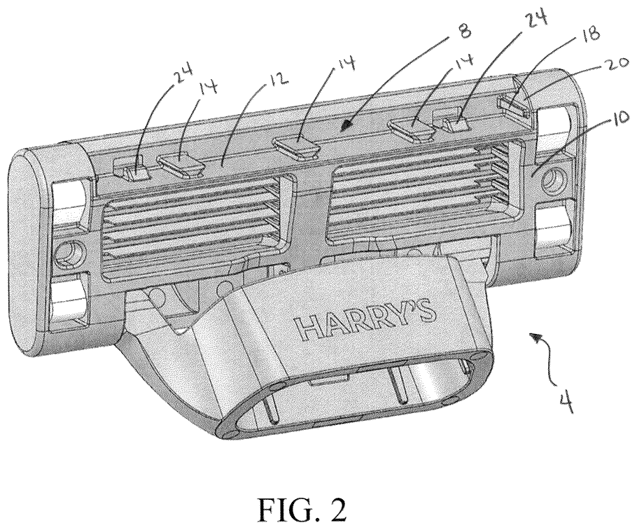

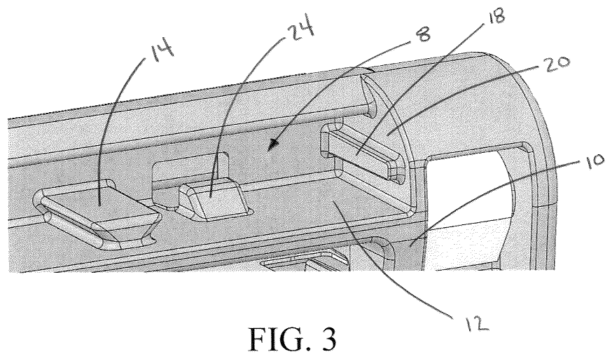

FIGS. 2 and 3 show the channel 8 within the rear surface 10, extending inwardly toward the front surface of the cartridge housing 4, for receiving the trimmer blade assembly 6. The channel 8 comprises a first interior channel wall 12 with a plurality of rails 14 that are to be received within rail guides 16 on the trimmer blade assembly 6. In the preferred embodiment, the rails 14 and cooperating rail guides 16 are formed in dovetail configurations that both guide the trimmer blade assembly 6 into proper alignment, limit movement of the trimmer blade assembly 6 in the X and Z axes to securely retain the trimming blade assembly 6 against the first interior channel wall 12.

The preferred channel 8 also includes alignment projections 18 extending from opposed lateral channel walls 20, which engage end portions 22 of the trimmer blade assembly 6 to hold the ends 22 of the trimmer blade assembly 6 in place, against the first interior channel wall 12. In the preferred embodiment, the alignment projections 18 are flared, so that the bottom of the leading edges are slightly farther from the first interior channel wall 12 with the distance decreasing as the alignment projections extend farther into the channel 8. This draws the trimmer blade assembly end portions 22 down against the first interior channel wall 12.

The first interior channel wall 12 also includes snap-fit projections 24 that engage snap-fit catches 26 on the trimmer blade assembly 6 to permanently lock the trimmer blade assembly 6 in the channel 8. The snap-fit projections 24 and catches 26 comprise ramped leading faces to facilitate movement of the trimmer blade assembly 6 into the channel 8 until the projections 24 pass the catches 26 and snap-fit into place, resulting in a secure, permanent attachment of the trimmer blade assembly 6 onto the first channel interior wall 12 of the channel 8.

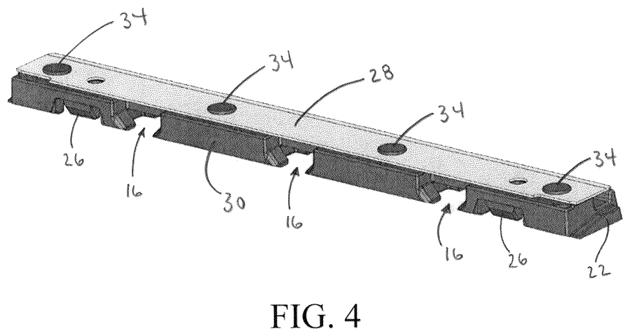

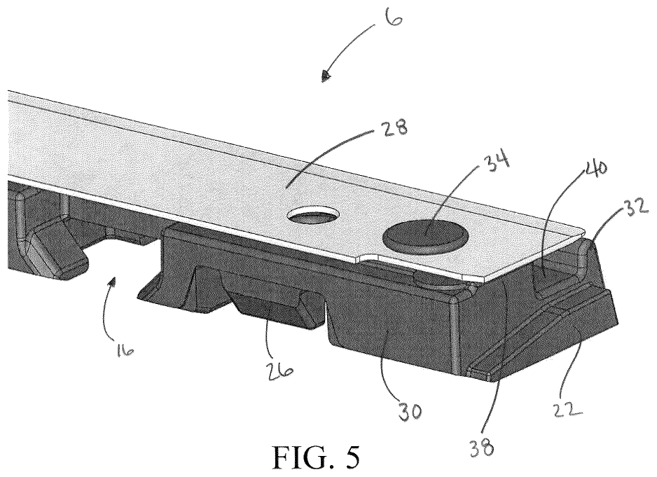

The trimmer blade assembly 6, best shown in FIGS. 4 and 5, comprises the trimmer blade 28 permanently attached to a trimmer blade support 30, said trimmer blade support 30 comprising a trimmer blade guard 32 at the leading end.

The trimmer blade support 30 of the preferred embodiment is made of a suitable plastic material, with the trimmer blade 28 attached by physically connecting the trimmer blade 28 to the trimmer blade support 30. In the embodiment shown, the trimmer blade support 30 has a number of projections 34 that are adapted to pass through corresponding apertures 36 in the trimmer blade 28, which can be melted and pressed, sonic welded, cold formed, etc., to securely hold the trimmer blade 28 on the trimmer blade support 30.

The trimmer blade support 30 comprises a platform 38 onto which the trimmer blade 28 is mounted and an extension 40 terminating in the trimmer guard 32, so that the trimmer blade 28 is mounted to the trimmer blade support 30 at a fixed, predetermined distance, allowing the end of trimmer blade support 30 to act as the trimmer guard 32.

As described in more detail above, the rail guides 16, snap-fit catches 26 and end portions 18 are formed on the trimmer blade support 30 to align and permanently attach the trimmer blade assembly 6 on the first interior channel wall 12. To cooperate with the dovetail shaped rails 14 on the first interior channel wall 12, the trimmer rail guides 16 are formed in a cooperating dovetail configuration. Additionally, the end portions 22 of the trimmer blade support 30 are preferably ramped at the leading edges up to a final raised height, corresponding to the distance between the interior channel wall 12 and the bottom of the alignment projections 18. The ramped end portions 22 ease alignment for insertion of the trimmer blade assembly 6 into the channel 8 and aid in drawing down the end portions 22 of the trimmer blade support 30 against the first interior channel wall 12.

In the preferred embodiment shown, the trimmer blade 28 extends substantially parallel to the first interior channel wall 12 on which the trimmer blade assembly 6 is mounted, almost perpendicular to the rear surface 10, with the trimmer blade support 30 extending beyond the cutting edge of the trimmer blade 28 to form the trimmer guard 32.

An open space exists between the trimmer blade 28 and a second interior channel wall 42, opposite the first interior channel wall 12, where a portion of the cartridge housing 4 adjacent the second interior channel wall 42 comprises the trimmer cap 44. In the preferred embodiment, the portion of the cartridge housing 4 adjacent the second interior channel wall 42 forming the trimmer cap 44 comprises a truncated top surface 46 of the cartridge housing 4. In this embodiment, the cutting edge of the trimmer blade 28 extends beyond the top surface 46 of the cartridge housing 4 but not as far as the trimmer guard 32 of the trimmer blade support 30.

The trimmer guard 32 of the trimmer blade support 30, the cutting edge of trimmer blade 28 and the trimmer cap 44 on the cartridge housing 4 adjacent the second interior channel wall 42 create the trimmer plane on the razor cartridge 2.

The present invention also comprises a method of manufacturing a razor cartridge 2 with a trimmer blade 28 based on the components described in detail above. The method preferably comprises providing a cartridge housing 4 with primary shaving blades on a front surface (not shown) and a channel 8 on a rear a surface 10, the channel 8 extending inwardly toward the front surface and comprising a plurality of rails 14 on a first interior channel wall 12. The method further includes providing a trimmer blade assembly 6, comprising a trimmer blade 28 attached to a trimmer blade support 30, the trimmer blade support 30 comprising a number of rail guides 16 equal to the number of rails 14 on the interior channel wall 12, and sliding the trimmer blade assembly 6 into the channel 8 on the cooperating rails 14 and rail guides 16 until snap-fit projections 24 on the first interior channel wall 12 engage snap-fit catches 26 on the trimmer blade support 30 to securely and permanently fix the trimmer blade assembly 6 within the channel 8 against the first interior channel wall 12 of the cartridge housing 4.

Variations, modifications and alterations to the above detailed description will be apparent to those skilled in the art. All such variations, modifications and/or alternatives are intended to fall within the scope of the present invention, limited only by the claims. Any cited patents and/or publications are hereby incorporated by reference.

We claim:

1. A razor cartridge comprising a housing with one or more primary blades mounted in a primary blade plane on a front surface of the housing, a channel within a rear surface of the housing, said channel extending inwardly from the rear surface toward the front surface, and a trimmer blade assembly comprising a trimmer blade securely attached to a trimmer blade support, said trimmer blade support comprising a trimmer blade guard, wherein the trimmer blade assembly is mounted on a first interior wall of the channel, and a portion of the housing adjacent a second interior channel wall opposite the first interior channel wall comprises a trimmer blade cap.

2. The razor cartridge of claim 1 wherein the trimmer blade assembly and the first interior channel wall comprise one or more cooperating rails and rail guides.

3. The razor cartridge of claim 2 wherein the one or more rails and rail guides comprise corresponding dovetail configurations.

4. The razor cartridge of claim 3 wherein the at least one dovetail configured rail is formed on the first interior channel wall and the cooperating dovetail configured rail guide is formed in the trimmer blade support.

5. The razor cartridge of claim 1 wherein the channel comprises opposed lateral walls, each of which comprise an alignment projection that engages end portions of the trimmer blade support.

6. The razor cartridge of claim 5 wherein the end portions of the trimmer blade support are ramped to aid engagement with the alignment projections.

7. The razor cartridge of claim 1 wherein the interior channel wall and trimmer blade support comprise cooperating snap-fit projections and snap-fit catches to permanently lock the trimmer blade assembly in the channel.

8. The razor cartridge of claim 1 wherein the trimmer blade is affixed to the trimmer blade support by a physical connection.

9. The razor cartridge of claim 1 wherein the trimmer blade support comprises a platform on which the trimmer blade is attached.

10. The razor cartridge of claim 1 wherein the trimmer blade support comprises an extension terminating in the trimmer guard.

11. The razor cartridge of claim 10 wherein the trimmer guard extends beyond a cutting edge on the trimmer blade.

12. The razor cartridge of claim 1 wherein the channel comprises a second interior channel wall opposite the first interior wall.

13. The razor cartridge of claim 12 wherein the trimmer blade is spaced from the second interior channel wall.

14. The razor cartridge of claim 13 wherein the housing adjacent the second interior channel wall comprises a trimmer cap.

15. The razor cartridge of claim 14 wherein the trimmer cap is formed at a terminal end of a top side of the housing.

16. The razor cartridge of claim 15 wherein the top side of the housing forming the trimmer cap is truncated, so a cutting edge of the trimmer blade extends beyond the trimmer cap.

17. A method of manufacturing a razor cartridge comprising:
providing a cartridge housing with primary shaving blades on a front surface and a channel on a rear a surface, said channel extending inwardly toward the front surface and comprising one or more rails or rail guides on a first interior channel wall;
providing a trimmer blade assembly comprising a trimmer blade attached to a trimmer blade support, said trimmer blade support comprising one or more rails or rail guides for cooperating with the one or more rails or rail guides on the interior channel wall;
sliding the trimmer blade support into the channel on the cooperating one or more rails and rail guides; and
fixing the trimmer blade assembly against the first interior channel wall.

18. The method of claim 17 wherein the rails and rail guides are formed in a dovetail configuration.

19. The method of claim 17 wherein the trimmer blade support comprises the trimmer guard.

20. The method of claim 17 wherein the housing comprises the trimmer cap.
